(19) United States
(12) Patent Application Publication
(10) Pub. No.: US 2014/0006273 A1
(43) Pub. Date: Jan. 2, 2014

(54) SYSTEM AND METHOD FOR BANK-HOSTED PAYMENTS

(71) Applicant: Infosys Limited, Bangalore (IN)

(72) Inventors: Ashok Gopinath, Bangalore (IN); Anurag Singh, Bangalore (IN); Arun Menon, Bangalore (IN)

(21) Appl. No.: 13/929,524

(22) Filed: Jun. 27, 2013

(30) Foreign Application Priority Data
Jun. 29, 2012 (IN) 2607/CHE/2012

(51) Int. Cl. G06Q 40/02

(52) U.S. Cl. CPC G06Q 40/02
USPC 705/40

(57) ABSTRACT

Described herein are representative tools and techniques for making bank-hosted payments. In one exemplary technique described herein, at least one payee account, at least one payer account, and at least one suspense account are maintained at a bank. Additionally, at least one client identifier is assigned to a software client. Further, at least one payment token is generated and the at least one payment token is issued to the software client. Also, funds are transferred from the at least one payer account to the at least one suspense account. Additionally, transaction information for an offline transaction is received. The transaction information includes the at least one payment token, a payment amount, and an issuer identifier. Using a portion of the transaction information, transaction authentication is performed, and based in part on the transaction authentication, funds are transferred from the at least one suspense account.

### BACKGROUND

As the use of mobile devices and the internet have become more prevalent, access to traditional internet technologies has expanded and retailers have used traditional internet technologies to allow customers to make purchases or payments. Although traditional methods of making payments are used, these traditional methods are limited.

### SUMMARY

Among other innovations described herein, this disclosure presents various tools and techniques for making bank-hosted payments. In one exemplary technique described herein, at least one payee account, at least one payer account, and at least one suspense account are maintained at a bank. Additionally, at least one client identifier is assigned to a software client. Further, at least one payment token is generated and the at least one payment token is issued to the software client. Also, funds are transferred from the at least one payer account to the at least one suspense account. Additionally, transaction information for an offline transaction is received, where the transaction information includes the at least one payment token, a payment amount, and an issuer identifier. Using at least a portion of the transaction information, transaction authentication is performed and based in part on the transaction authentication, funds are transferred from the at least one suspense account.

This summary is provided to introduce a selection of concepts in a simplified form that are further described below. This summary is not intended to identify key features or essential features of the claimed subject matter, nor is it intended to be used to limit the scope of the claimed subject matter. The foregoing and other objects, features, and advantages of the technologies will become more apparent from the following detailed description, which proceeds with reference to the accompanying figures.

### BRIEF DESCRIPTION OF THE DRAWINGS

FIG. 1 is a schematic diagram of an exemplary system for performing a bank-hosted payment using an offline transaction.

FIG. 2 is a flowchart of an exemplary method of performing a bank-hosted payment using an offline transaction.

FIG. 3 is a schematic diagram of an exemplary payment system that can perform an offline transaction according to a bank security protocol using a software client.

FIG. 4 is a flowchart of an exemplary method for performing an offline transaction according to a bank's security protocol using a software client provided by the bank.

FIG. 5 is an exemplary implementation of a bank payments server of a bank.

FIG. 6 is an exemplary method for making a bank-hosted payment by performing an offline transaction using a software client.

FIG. 7 is a schematic diagram showing an example of a payer client that is online with a bank.

FIG. 8 is a schematic diagram showing an example of a payee client that is online with a bank.

FIG. 9 is a schematic diagram showing an example of a payee client and a payer client that are online with a bank.

FIG. 10 is a schematic diagram illustrating a generalized example of a suitable computing environment for any of the disclosed embodiments.

### DETAILED DESCRIPTION

### Exemplary System for Bank-Hosted Payments Conducted using Offline Transactions

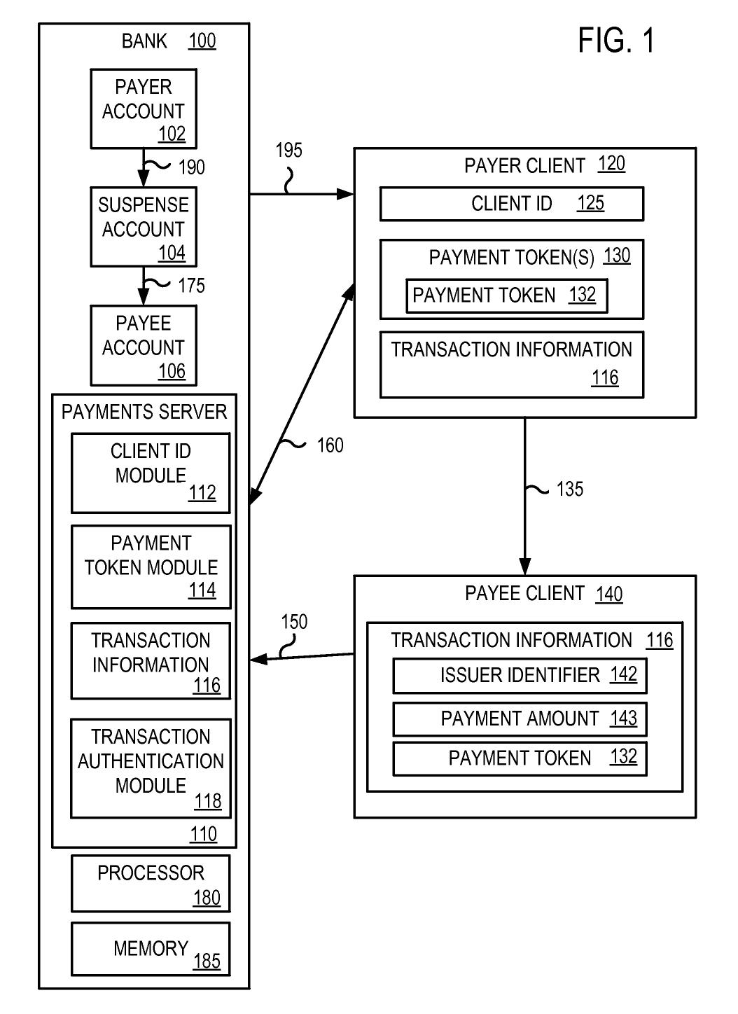

FIG. 1 is a schematic diagram of an exemplary system for conducting bank-hosted payments using offline transactions. As shown in FIG. 1, the exemplary system can include a bank 100 that includes a banking system with at least one processor 180 and memory 185 and one or more bank provided or otherwise bank authorized software clients such as payer client 120 and payee client 140. For example, in a bank-hosted payment, a payer who has an account at the bank can use the bank authorized software client to make online or offline transactions for payment of money to a payee that also has an account at the bank, and the transfer of money between the payer and the payee accounts is conducted by the bank. In FIG. 1, the bank 100 includes and maintains one or more payer accounts such as payer account 102. The payer account 102 can hold funds and be maintained for a payer that has an established relationship with the bank such as a person or business that is a customer of the bank. The bank 100 includes and maintains one or more a suspense accounts such as suspense account 104. The suspense account 104 can include funds authorized to be transferred by the bank upon authentication of an offline transaction conducted between a payer and one or more a payees. The suspense account 104 can be associated with the payer account such that the suspense account is funded by one or more intra-bank transfers of money from the payer account as shown at 190. The bank 100 includes and maintains one or more payee accounts such as payee account 106. The payee account 106 can hold funds and be maintained for a payee that has an established relationship with the bank such as a person, business, or merchant that is a customer of the bank. The bank 100 can include a payments server 110. Also the bank 100 can provide one or more software clients such as payer client 120 and payee client 140 to one or more payees and/or payers that have accounts with the bank.

In FIG. 1, the payments server 110 includes a client identifier module 112, a payment token module 114, a transaction authentication module 118. The payments server 110 can also include and/or receive transaction information such as transaction information 116. The client identifier module 112 can generate and store one or more unique client identifiers that can uniquely identify software clients when assigned to software clients. For example, the client module identifier can generate a client identifier 125 and assign it to the payer client 120 to uniquely identify the payer client 120. In some implementations, a copy of the client identifier 125 can be store by the payments server 110 and used to authenticate transactions and to associate the uniquely identified software client with a payer account and/or a suspense account for a payer. The payment token module 114 can generate and store one or more payment tokens that can be unique identifiers used to authenticate transactions made by software clients. As shown, the payment server generates and as shown at 195 the payments server issues payment tokens 130 which include payment token 132 to the payer client 120 that was assigned the client identifier 125. The payments server stores a copy of the payment token 132 and the information that the payment token 132 was issued to a client identified by the client identifier 125. The transaction authentication module 118 can authenticate an online or offline transaction for a purchase or payment made using software clients provided by the bank 100 that employ a security protocol.

In the example shown in FIG. 1, the payer client 120 and payee client 140 can be offline such that the clients do not have an active communication connection with the bank and/or cannot access online services or an online payment portal of the bank 100. For example, the clients can be on mobile devices that temporarily do not have cellular service and/or internet connectivity that would allow the clients to communicate with the bank 100. While the payer client 120 and the payee client 140 are offline, a purchaser or payer can use the payer client 120 to conduct an offline transaction 135 with the payee client 140 to make a payment to a payee such as a person, business, or retailer. During the transaction 135, the payer client 120 can communicate the payment token 132 as well as the client identifier 125 to the payee client 140. In some implementations, for an online or offline transaction, the payer client can communicate the payment token and a client identifier and/or other information about the transaction using one or more technologies for communicating data such as Near Field Communication, text messaging technologies (e.g., Short Message Service (SMS)), email, a Quick Response Code (QR code), a social networking message, and/or other data communication technologies. The communicated client identifier 125 can be used as an issuer identifier 142 to identify the payer client 120 as the issuer of the payment token 132. After the offline transaction is conducted, the payer client 120 can come online with the bank 100 as shown at 160, or the payee client 140 can come online with the bank as shown at 150. When online with the bank, the payer client 120 or the payee client 140 can transmit transaction information 116 to the payments server 110. The transaction information 116 can include the issuer identifier 142, a payment amount 143, and the payment token 132. In some implementations of transaction authentication, the transaction authentication module 118 uses the bank's stored copy of the payment token 132 and the bank's stored copy of the client identifier 125 to verify that the issuer identifier 142 of the received transaction information 116 identifies the same payer client that was issued the received payment token 132. In one implementation, if the offline transaction is authenticated, an intra-bank transfer of funds as shown at 175 is conducted by moving funds from the suspense account 104 (e.g., the suspense account is debited) to the payee account 115 (e.g., the payee account is credited) based on the payment amount 143 of the transaction information 116 received by the payments server 110.

### Exemplary Method for Performing a Bank-Hosted Payment Using an Offline Transaction

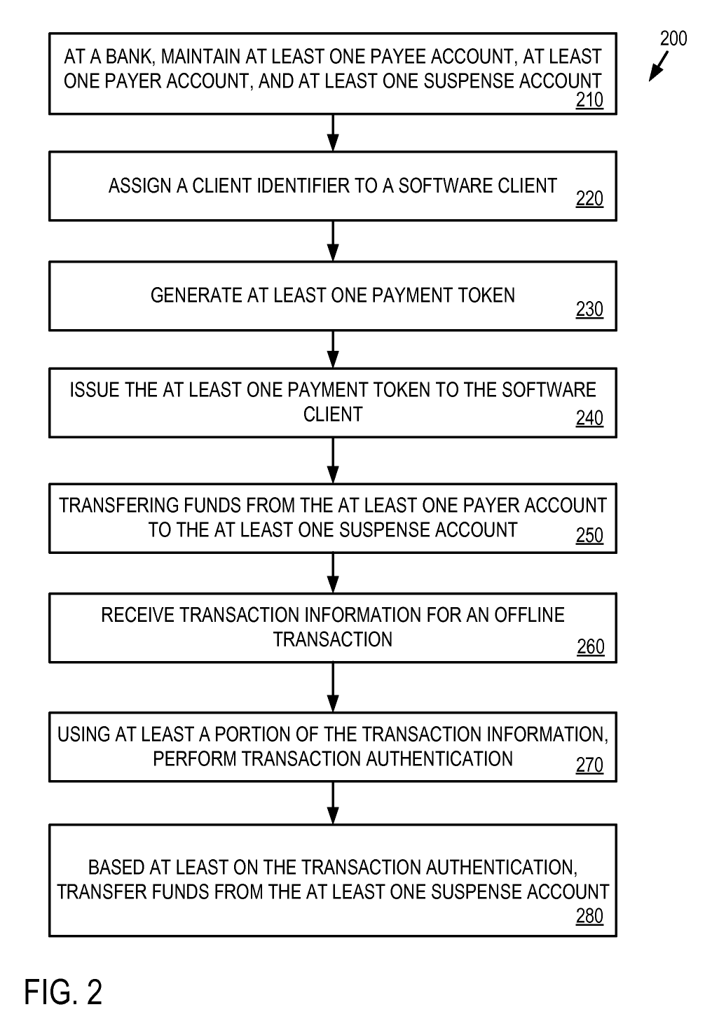

FIG. 2 is a flowchart of an exemplary method 200 of performing a bank-hosted payment using an offline transaction. In one exemplary implementation of a bank-hosted payment, a bank provides software (e.g., a software client or other software) to a payer (e.g., a buyer, or other payer of money) and a payee (e.g., a seller or other payee or money) to make the payment between the payer and the payee, and the bank is the financial conduit for the actual money transfer between the payer and payee.

In the example shown in FIG. 2, at least one payee account, at least one payer account, and at least one suspense account are maintained by a bank at 210. For example the at least one payee account, the at least one payer account, and the at least one suspense account can be bank accounts provided by the bank, and the bank can transfer funds between the accounts using intra-bank transfers. In one example, an intra-bank transfer can be a transfer of funds (e.g., money) from one bank account provided by a bank to another bank account provided by the bank without transferring the funds to a financial institution other than or different than the bank. In one implementation, a bank account maintained by the bank can be a personal, business, commercial or a bank controlled and/or owned account. For example, a payee and/or payer account can be a bank account opened, controlled, owned, and/or used by a customer of the bank. In one example of a payer account, the payer account is a personal bank account of a person who is a customer of the bank. In other examples, the payer account can be a bank account provided by the bank for a customer of the bank that is a merchant, a business, or another customer of the bank. In one example of a payee account, the payee account is provided by the bank as an account for a merchant or retailer that is a customer of the bank. In other examples of payee accounts, the payee accounts can be provided by the bank for a person, business, and/or another customer of the bank.

In one implementation of a suspense account, the suspense account can be a bank account that holds funds transferred from a payee account of a payee that are held and/or controlled by the bank. For example, the bank can be authorized to transfer some or all of the suspense account funds to a payer account to complete a payment of money from a payer to a payee that uses an offline transaction authenticated as appropriate according to a security protocol. In some examples of a suspense account, the suspense account holds funds in escrow to complete payments made using offline transactions. In other words, the suspense account holds funds that guarantee the payment of money made in an offline transaction authenticated as following a security protocol.

The example of FIG. 2 continues such that a client identifier is assigned to a software client at 220. For example, a payments server of the bank can generate an identifier and issue the identifier to a software client provided by the bank. In some implementations of a client identifier, the client identifier can be a generated globally unique identifier (GUID), or a universally unique identifier (UUID) such as a UUID generated to conform to the Open Software Foundation's UUID version 5 (with SHA-1 hashing) as documented in ISO/IEC 11578:1996. In one implementation, the client identifier is generated and/or issued to a software client when the software client first starts up, first connects to a payments server of the bank, and/or is first activated to be used for bank-hosted payments. In some implementations, once issued to the software client, the client identifier is stored in the device that includes the software client. The client identifier can be a permanent identifier for the software client, or a temporary identifier for the software client. In some implementations, the issued client identifier is encrypted using a key unique to the device with the software client. For example, the device identifier can be one supplied by an operating system of the device, or some other device identifier of the device. In some implementations of the software client, the software client can be a bank software client that is provided by a bank or authorized to make payments hosted by the bank. For example, a user of a mobile device can download an application that implements the software client from the bank or a bank authorized distributor of the software client and install it on the mobile device. In some implementations of issuing client identifiers, once a particular client identifier is issued by a bank to a software client, the bank cannot reissue or again issue that same particular client identifier to a different software client such as another instance of the bank software client on another device or a different instance of the bank software client on the same device. In some implementations of issuing client identifiers, a bank can store copies of the issued client identifiers which can be used in transaction authentication and/or to verify that the bank does not issue two different bank provided software clients the same client identifier.

At 230, at least one payment token is generated. For example, a payment token can be a universally unique identifier (UUID), or other unique identifier. In some implementations, one or more payment tokens can be generated by a bank such as by a payment token module of a payments server of a bank or bank system.

At 240, the at least one payment token is issued to the software client. For example, once a payment token is generated the payment token can be issued to a bank software client (e.g., payer client) for use to conduct payments using online or offline transactions. In some implementations, once a payment token is issued to a software client identified by a client identifier, the issued payment token cannot be reused or issued to a different software client or re-issued to the same software client. In some implementations, once an issued payment token is used for an authenticated online or offline transaction, the issued payment token is not and/or cannot be re-issued by the bank to a bank software client. In some implementations, a predetermined number of payment tokens (e.g., N payment tokens) can be issued to a software client when the software client first connects to a payments server of the bank. In some implementations, when the software client reconnects to the payments server of the bank and the software client has less than a predetermined number of issued payment tokens, the payments server can issues the software client enough payment tokens so that the software client has the predetermined number of issued payment tokens. The issuance of payment tokens to the software client can be part of a synchronization process between the software client and the payments server after the software client reconnects and comes online with the server. In some implementations of issuing a payment token, a bank can store copies of the issued payment tokens. Also, in some implementations, the bank can store token-client association information associating respective stored and issued payment tokens with respective client identifiers of the software clients that were issued the respective stored payment tokens. In some implementations, the stored issued payment tokens, the token-client association information and stored issued client identifiers can be used in transaction authentication and/or for verification that the bank does not reissue or reuse a previously issued payment token.

In some implementations of issuing payment tokens, at the time of issuance, the payment tokens can be given a validity time such that the payment token is authorized for use for a limited and/or predetermine amount of time. In one example, a validity time of a payment token can be determined based on whether it can be used for an online of offline transaction. In another example, the validity time of a payment token can be determined based on the format or method used for transferring payment. In one implementation, if a validity time for a payment token has expired before the payment token is used, if the payment token is provided to a payments server of the bank to redeem payment for a transaction, the transaction can be deemed to be not authenticated and the bank can deny payment of the transaction.

In some implementations of issuing payment tokens, the payment tokens can be issued with payment amount ranges. For example, a payment amount range for a payment token can indicate a range of money that can be authorized for payment in online or offline transactions using the payment token. That is to say the payment range for the payment token gives a range of possible payment amounts for online or offline transactions that can be paid using the payment token.

At 250, funds from the at least one payer account are transferred to the at least one suspense account. For example, a payer can designate an amount of money to be an offline transaction limit for a payer client and the designated amount of funds can be transferred to the suspense account from the payer account. In one implementation, a payer using a payer client can enable the payer client for making payments offline. Once enabled for offline payments, an offline transaction limit can be designated and set while the payer client is online, and the designated amount of funds is transferred by the bank from the payer account to a suspense account associated with the payer and/or the payer client. In some implementations, the suspense account is associated with a payer client and/or a payer such that the suspense account holds funds in escrow to make payments for offline transactions conducted between the payer, using the payer client, and one or more payees with respective payee accounts at the bank.

At 260, transaction information for an offline transaction is received. For example, a payer conducts an offline transaction with a payee, and when the payee client of the payee comes online with the bank, the payee client sends information about the transaction to the bank to complete the payment of money. In another implementation, the transaction information is communicated to the bank by the payer client when the payer client comes online after the offline transaction. In some implementations of transaction information, the transaction information can include a payment amount, an issuer identifier, a client identifier issued to the payer client, a payment token, tax information, information about the payer, information about the payee, product information, bank account numbers, a phone number of the device with the payer client, a phone number of the device with the payee client, bank information, and/or other information about a transaction for a payment or purchase. In some implementations, the transaction information can be communicated using one or more messages. In one implementation, the payment token included in the transaction information is a payment token issued to the payer client which is communicated to the payee client during the offline transaction. In some implementations, the issuer identifier included in the transaction information is the client identifier issued to the payer client which is communicated to the payee client during the offline transaction along with an issued payment token. Thus an issuer identifier can identify a payer client that issues or communicates a payment token to a payee client in an offline transaction. In one implementation, the issuer identifier is not sent by a payer client or payee client, and the payments server can look up or retrieve a stored client identifier issued to a payer client on a mobile device with a phone number that is included in the transaction information, and the payments server can use the retrieved client identifier as the issuer identifier for transaction authentication purposes. In some implementations, the payment amount is the amount of money that is paid from the payer to the payee using the offline transaction. The information about the payee can include information that identifies the payee and which payee account is to be funded to redeem the value of the offline transaction.

In some implementations, when a software client sends transaction information to the bank the implementation of the software client can determine how the transaction information is passed to the payments server. In some implementations, transaction information is communicated to the bank in other forms such as in printed form. For example, a payee can print the transaction information for an offline transaction conducted with a payee client and the payee can give the printed transaction information to a bank employee such as a bank teller, and the employee can enter the transaction information into the bank's systems for authentication and/or payment. In some implementations of transaction information, for transfer purposes, the transaction information can include a public identifier of the payee that is different than what is designated by the payments server, so the payments server can store a mapping of public identifiers of payees with the corresponding payments server designated identifiers. The stored mapping can be used by the payments server to determine the payee to be paid for an authenticated payment made using an offline transaction.

At 270, transaction authentication is performed using at least a portion of the transaction information. For example, when a bank receives transaction information from a payee to redeem the amount of money or value of the offline transaction (e.g., offline payment or purchase), the bank can use the issuer identifier and the payment token of the transaction information to verify that the payer client that issued the payment token to the payee during the offline transaction is the same payer client that was issued the payment token by the payments server. In some implementations of transaction authentication, when transaction information is communicated to the bank to transfer funds for the payment amount of the offline transaction, a payment token and issuer identifier included in the transaction information are compared with a stored payment token and the stored client identifier for the payer client that was issued the payment token. If a stored and issued payment token corresponds to (e.g., matches) the payment token included in the transaction information, and the stored and issued payment token was issued to a payer client identified by a stored and issued client identifier that corresponds to (e.g., matches) the issuer identifier included in the transaction information, then the payments server can authenticate the offline transaction as valid according to the bank's security protocol. In some implementations of transaction authentication, if the payment token included in the transaction information does not match a stored and issued payment token at the bank, the payments server can indicate that the offline transaction was not valid according to the bank's security protocol, and the bank can deny a transfer of funds and not complete payment of the offline transaction. In another implementation of transaction authentication, if a stored and issued payment token matches the payment token included in the transaction information, and the stored and issued payment token was issued to a payer client identified by a stored and issued client identifier that does not match the issuer identifier included in the transaction information, then the payments server can indicate that the offline transaction is not valid according to the bank's security protocol and the bank can deny a transfer of funds and not complete payment of the offline transaction.

At 280, based at least on the transaction authentication, funds are transferred from the at least one suspense account. For example, a payments server can authenticate an offline transaction as being valid according to the bank's security protocol and the bank can transfer funds from the suspense account to the payee account of the payee of the offline transaction. In one implementation, for an authenticated offline transaction, the bank can transfer funds from the suspense account held at the bank for the payer client was issued the client identifier that corresponded to (e.g., matched) the issuer identifier used in the transaction authentication. In one implementation of a funds transfer from a suspense account, the funds are transferred by the bank using an intra-bank transfer. In some implementations of transferring funds from a suspense account, the funds transferred from the suspense account are transferred to a payee account. For example, the funds transferred from the suspense account can be transferred to a payee account of the payee associated with the payee client identifier indicated in the transaction information.

In some implementations of a bank-hosted payment, after funds are transferred from a suspense account to a payee account, funds can be taken from the payer account (e.g., the payer account is debited) and transferred to the suspense account (e.g., the suspense account is credited) so that the suspense account has enough funds to maintain the payer's offline transaction limit set using the payer client.

In some implementations of bank-hosted payments, after a money transfer has been made from a suspense account to a payee account to complete a payment, a payer client and/or a payee client may be notified by the bank using one or more messages that the payment has been completed by the bank.

### Exemplary Payment System for Performing an Offline Transaction Using a Software Client Provided by a Bank

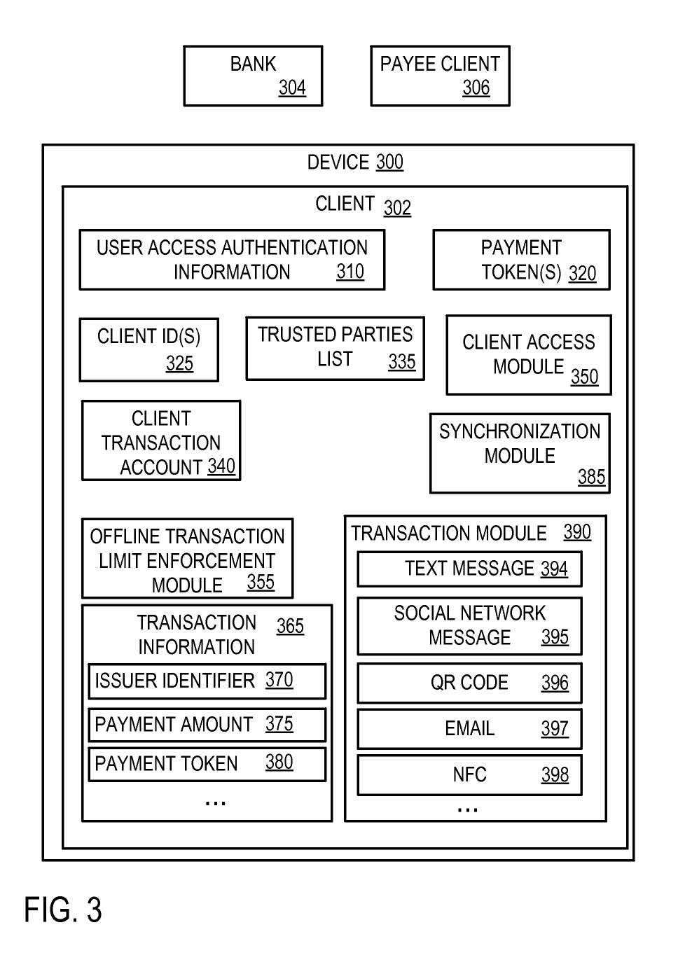

FIG. 3 is a schematic diagram of an exemplary payment system that can perform an offline transaction according to a bank security protocol using a software client provided by a bank. The exemplary payment system shown in FIG. 3 can include a computing device such as device 300 that includes a software client for a payer such as payer client 302 that is provided by a bank 304. The exemplary payment system shown in FIG. 3 also includes a software client for a payee such as payee client 306 that is provided by bank 304. The payee client 302 can include and/or store user access authentication information 310, one or more payment tokens 320, one or more client identifiers 325, a trusted parties list 335, and/or transaction information for one or more online or offline transactions such as transaction information 365. The transaction information 365 can include an issuer identifier 370, a payment amount 375, and a payment token 380. In some implementations, there can be one or more sets of transaction information stored at the client 302 where a single set of transaction information is for a single transaction. The payer client 302 can also include a client transaction account 340, a client access module 350, an offline transaction limit enforcement module 355, a synchronization module 385, and a transaction module 390. In some implementations of a software client such as payer client 302, the software client can have a customized front end and/or user interface where the customization depends on the business needs of the bank. The payer client 302 can be accessible from the device 300, whether or not the device is connected to the internet or a cellular network for example the payer client 302 can be a native application on the device 300. For example the payer client can be a mobile phone application (mobile app) on a mobile phone, or an application in a kiosk.

The user access authentication information 310 can be stored by the device 300, and can be used to verify that a user is authorized to use the payer client 302 as part of a security protocol of the bank 304. In one implementation, the user access authentication information 310 is stored on the device 300 after being encrypted. For example, the user access authentication information 310 can be encrypted using a form of encryption such as 128 bit AES encryption, a system level encryption of the device, and/or other forms of encryption. The user access authentication information 310 can be provided to the client by one or more users upon activation or as part of activation of the payer client 302 with the bank 304, or while the client is online with the bank 304 so that the bank can verify that the user is a customer of the bank and can be authorized to make bank hosted payments using the payer client 302.

The client access module 350 can provide a portion of the security protocol for the bank 304. The client access module 350 can authenticate user access in that the client 350 can restrict or allow a user's access to the payer client 302 for one or more uses such as configuration of the payer client, changing the user's banking information or authorizations, making online or offline payments and transactions, and/or other functionality of the payer client 302. The client access module 350 while offline or online can authenticate and allow access to a set of users that are authorized to use the client 302, and the client access module can deny access to the functionality of the client for unauthorized users.

In one exemplary implementation of user access authentication, after a payer or payee client is acquired (e.g., downloaded and/or installed on a device) the software client can be activated (e.g., activated in part for online or offline transactions) in part by having a user (e.g., a payer and/or payee) enter a username and a password or personal identification number (PIN). The entered username is encrypted such the entered password or PIN is the key used for the encryption. That is to say that the key used for the encryption can allow for the decryption of the encrypted authentication information. The encrypted username can be stored by the device as the user access authentication information for the user. Later when the user logs into the client software for access, the user can enter the username and password or PIN, and the entered password or PIN can be used as a key to decrypt the stored user access authentication information for the user. If the entered username matches the decrypted username of the user access authentication information for the user, the user is allowed access to the client. If the entered username does not match the decrypted username, then the user can be denied access to use the client. In one implementation, a single username, and a single password or PIN is used to authenticate a single user of the payer client 302. In other implementations a single user can have more than one username and password or PIN to access the client 302. In some implementations of activation of a software client, the activation process confirms that the user is a customer of the bank and has a bank account with the bank that can be used as a payer or payee account.

The one or more payment tokens 320 can be encrypted and stored on the device 300 and can be used by the client 302 in encrypted or decrypted form. The trusted parties list 335 can include a list of one or more trusted parties such as people, businesses, and/or retailers that the payer client 302 can conduct transactions with (e.g., can only conduct transactions with) offline to make payments. In one implementation, a user of the payer client 302 can add a trusted party to the list of trusted parties by entering a personal identification number into the client that is validated by the payer client 302 and/or the bank 304.

In FIG. 3, the client transaction account 340 is a locally stored and updated balance on the device 300 of how much money the payer client 302 is authorized to pay using offline transactions. The balance of the client transaction account 340 is kept by the payer client and the transaction limit for the payer client while offline from the bank is the balance of the client transaction account. If a payment to be made while offline will exceed the transaction limit of the payer client, the offline transaction limit enforcement module 355 can prohibit the offline transaction from being conducted by the payer client 302. The balance of the client transaction account 340 is reduced or debited by an amount paid through an offline transaction. The balance of the client transaction account 340 can be increased or credited when the payer client is online with the bank and funds are transferred to a suspense account that match an offline transaction limit amount that is set for the client 302. In other words, when the payer client 302 is online with the bank 304, the balance of client transaction account can synchronize with the balance of the suspense account holding money in escrow for the payer client's transactions. For example, when the payer client 302 is online with the bank 304, the balance of the client transaction account balance is set to the balance of the suspense account so the balance of the client transaction account and the suspense account balance are the same. When the payer client conducts an offline transaction, the client transaction account balance is updated such that it is reduced the amount paid in the offline transaction. In some implementations, the balance of the client transaction account 340 and the corresponding suspense account balance at the bank 304 can be different when the client 302 is offline from the bank and conducts offline payments using offline transactions. The balance of the client transaction account 340 can be encrypted and/or stored on the device 304.

The transaction module 390 can be used to make online and offline transactions. In one example of making a payment using an online transaction, where the payer client 302 and/or the payee client 306 is online with the bank 304, funds are transferred form the suspense account (e.g., the suspense account is debited) to the payee account (e.g., the payee account is credited) at the time of the transaction because the transaction module of the online client communicates the transaction information at the time of the transaction. In one implementation of an online transaction, the payer client can be offline with the bank and the payer client's client transaction account balance may not be reflected equal to the suspense account balance after the payment is made. In one implementation of an offline transaction, the transaction module 390 can transmit one or more payment tokens, one or more client identifiers and/or other transaction data during an online or offline transaction using one or more data communication technologies such as a text message 394, social network message 395, a QR code 306, email 397, and/or NFC.

In some implementations of a payer client, the payer client can have the capability to generate and scan a QR code, send an SMS message, read NFC or RFID tags, emulate an NFC or RFID tag, and transmit other forms of digital messages such as Unstructured Supplementary Service Data (USSD) messages, Bluetooth, Infrared, email, social network messages, barcodes, and/or other forms of digital messages.

### Exemplary Method for Making a Bank-Hosted Payment by Performing an Offline Transaction Using a Software Client Provided by a Bank

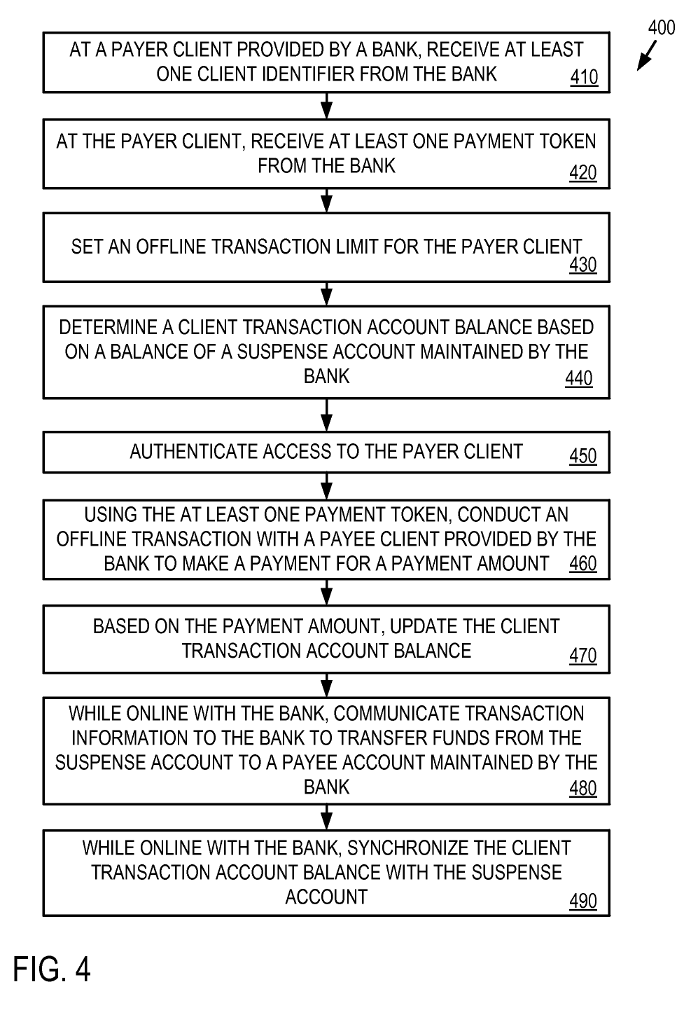

FIG. 4 is a flowchart of an exemplary method 400 for making a bank-hosted payment by performing an offline transaction according to a bank security protocol using a software client provided by a bank. In FIG. 4, at least one client identifier is received from a bank by a payer client provided by the bank at 410. At 420, at least one payment token is received from the bank at the payer client. At 430, an offline transaction limit is set for the payer client. For example, by setting a limit for the amount of money the payer client is authorized to pay using offline transactions, the payer client is delegated limited autonomy to enable payment while offline. In one implementation, a payer using a payer client can enable the payer client for making payments offline. Once enabled for offline payments, an offline transaction limit can be designated and set while the payer client is online with the bank, and the designated amount of funds is transferred by the bank from the payer account to a suspense account associated with the payer and/or the payer client. At 440, a client transaction account balance is determined based on a balance of a suspense account maintained by the bank. For example, while online the client transaction account balance is set to the offline transaction limit which can be an amount up to the amount of the suspense account balance. At 450, access to the payer client is authenticated. At 460, using the at least one payment token, an offline transaction is conducted with a payee client provided by the bank to make a payment for a payment amount. For example, the payer client can transmit a payment token and the issued client identifier of the payer client to the payee client so that the payee can redeem payment for the value of the transaction. In some implementations, the value of the transaction can be the value of what the payee is owed for a purchase of goods or services and/or the amount of money the payee client submits as the payment amount for the transaction. In one implementation of an offline transaction, as part of the bank's security protocol, the user can be prompted to enter a PIN at the payer client that can be verified by the payer client to authorize the offline transaction. In one implementation of an offline transaction, as part of the bank's security protocol, the user can be prompted to enter a PIN at the payer client that can be verified by the payer client to authorize that the offline transaction can be conducted with a new party or a party that is not included in a trusted parties list of the payer client. In one implementation of an offline transaction, the payer client can select a payment token with a payment amount range that includes a payment amount that is greater than or equal to the payment amount for the offline transaction, and use the selected payment token in the offline transaction. Selecting a token with a payment amount range that includes a payment amount greater than or equal to the transaction payment amount can be part of the banks security protocol. For example, if transaction information containing a payment token is provided to a bank to redeem payment for an online or offline transaction for an amount that exceeds the payment amount range of the payment token the online or offline transaction can be deemed invalid and not authorized and the bank can deny payment for the offline transaction. Also for example, if transaction information containing a payment token is provided to a bank to redeem payment for an online or offline transaction for an amount that does not exceed the payment amount range of the payment token the online or offline transaction can be deemed valid and authorized according the banks security protocol and the bank transfer money to a payer in complete payment for the offline transaction. At 470, the client transaction account balance is updated based on the payment amount. For example, the transaction account balance can be lowered by the payment amount of the offline transaction. At 480, while online with the bank, transaction information is communicated to the bank to transfer funds from the suspense account to a payee account maintained by the bank. At 490, while online with the bank, the client transaction account balance is synchronized with the balance of the suspense account. For example, when the payer client comes online with payments server of the bank, and the offline transactions made by the payer client have been paid from the suspense account, the balance of the transaction account is set to match the balance of the suspense account. In some implementations, during the synchronization the suspense account is credited with funds from the payer account to match the designated offline transaction limit set by the payer for offline transactions by of the payer client.

### Exemplary Payments Server

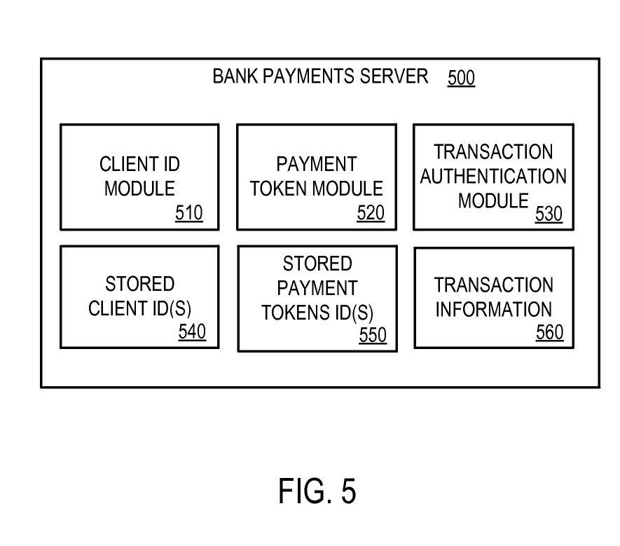

FIG. 5 is an exemplary implementation of a bank payments server 500 of a bank. The payments server 500 can be implemented in part using one or more computing devices, and one or more of the modules of payments server 500 can be implemented in part using computer-executable instructions. As shown in FIG. 5, the bank payments server 500 includes a client identifier module 510 that can generate and issue one or more client identifiers, a payment token module 520 that can generate and issue one or more payment tokens, and/or a transaction authentication module 530 that can perform transaction authentication of online and offline transactions. The payments server 500 can store one or more issued client identifiers 540, and store one or more issued payment tokens 550. The payment server 500 can also provide functionality for online authentication, secure communication over http, integrating with core-banking systems, and logging. The payments server can receive, use and store one or more sets of transaction information 560. The payments server 500 can be implemented as a combination of one or more bank devices, software, and/or components of a bank.

### Exemplary Method for Making a Bank-Hosted Payment by Performing an Offline Transaction Using a Software Client Provided by a Bank

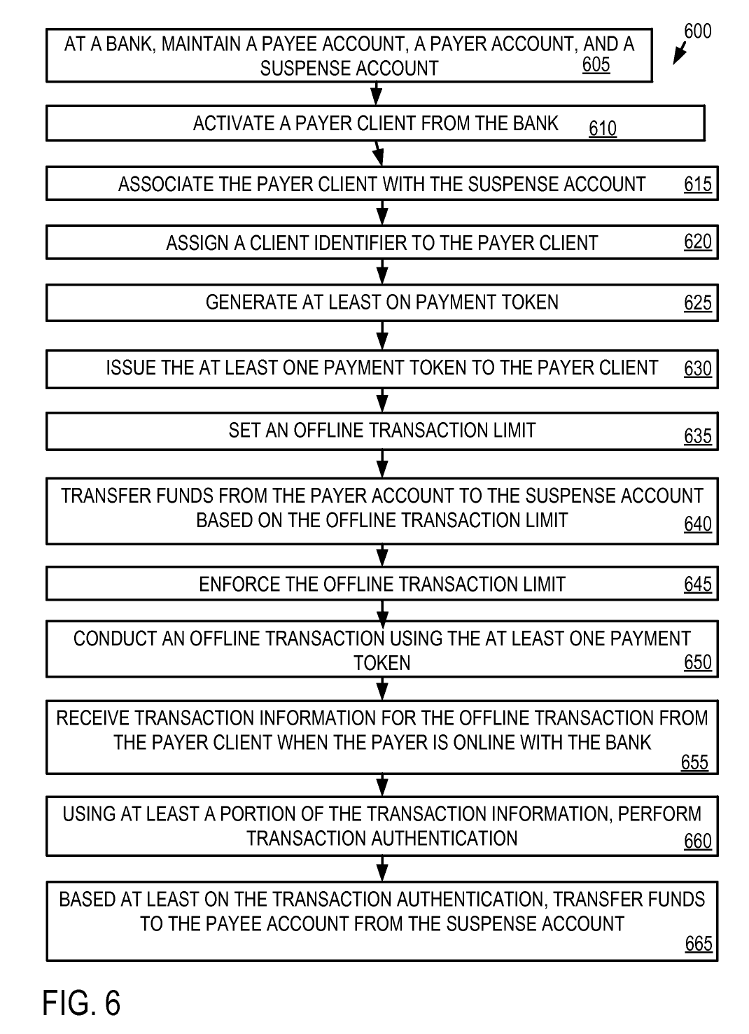

FIG. 6 is an exemplary method 600 for making a bank-hosted payment by performing an offline transaction using a software client provided by a bank. In FIG. 6, at least one payee account, at least one payer account, and at least one suspense account are maintained at a bank. At 610, a payer client provided from a bank is activated. For example, a user can install the software client and become authorized by the bank to use the software client to make bank-hosted payments. In some implementations, a user can be authorized to use one instance (e.g., only one instance) of the software client at a time to make payments using offline transactions. In other implementations, a user can be authorized to use more than one instance of the software client to make payments using offline transactions. In one implementation, when a user can be authorized to use one software client for offline transactions at a time, the user can change the software client designation while online with the bank and/or using a PIN. In some implementations, during activation the user provides an email address, a phone number, and a social network identifier as part of the client activation process. In some implementations of client activation, the user's relationship as a valid customer can be verified by the bank before the user can use the client for making payments.

As shown at 620, a client identifier is assigned to the payer client. At 625, at least one payment token is generated. For example, a payments server of the bank providing the payer client can generate one or more payment tokens. At 630, at least one payment token is issued to the payer client. For example, a payments server of the bank can issue the payer client one or more payment tokens while the payer client is online with the bank. At 635, an offline transaction limit is set based on an amount of funds in the suspense account. At 640, funds are transferred from the payer account to the suspense account based on the offline transaction limit. At 645, the offline transaction limit is enforced. For example, a user of the payer client attempts to make a payment while offline that exceeds the offline transaction limit for the payer client device and the payer client does not allow the transaction to be conducted. At 650, an offline transaction is conducted using the at least one payment token. At 655, transaction information for the offline transaction is received from the payer client when the payer client is online with the bank. At 660, transaction authentication is performed using at least a portion of the transaction information. At 665, based on the transaction authentication, funds are transferred to the payee account from the suspense account. For example, the funds are transferred to the payee account to complete the payment of money from the payee to the payer of the offline transaction.

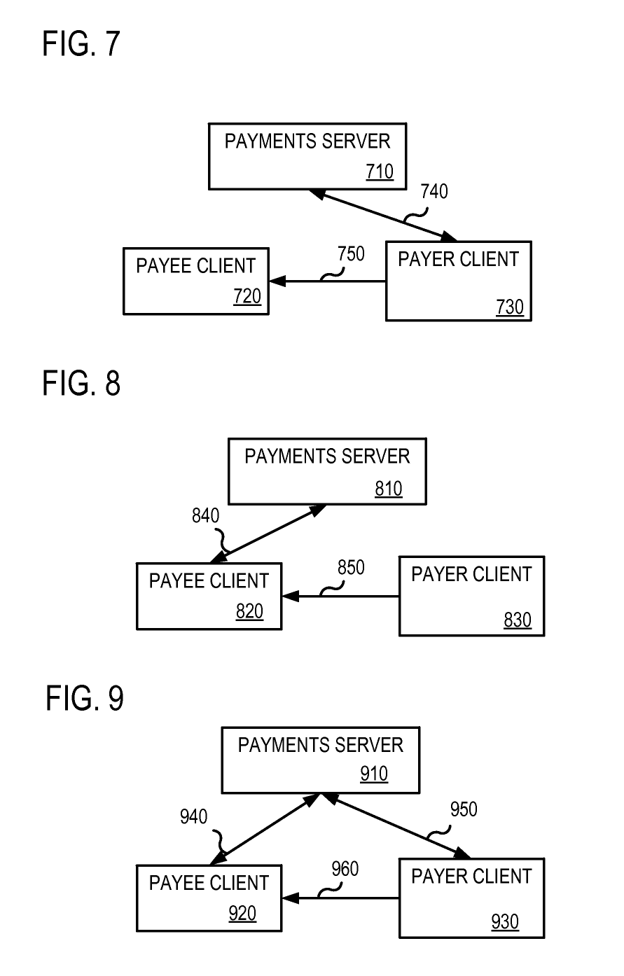

FIG. 7 is a schematic diagram showing an example of a payer client 730 that is online with a bank. In FIG. 7, the payer client 730 makes a connection 740 to the payments server 710 to come online with the bank after an offline transaction 750 has been conducted or completed. In other implementations, the payer client 730 comes online with the bank by connecting to another system of the bank such as a payment portal, website, or other online service of the bank. The connection 740 can be made using a suitable communication means such as the internet, internet technologies, or other communication means. In the example, the connection 740 can be used to transmit transaction information, synchronize the payer client with a suspense account, transmit one or more client identifiers or payment tokens to communicate transaction information, and/or conduct other communications between the payer client and the payments server while the payer client is online with the payments server. In FIG. 7, the payee client 720 is not online with the payments server 710 after the offline transaction 750 has been conducted between the payer client 730, and payee client 720. As the payer client 730 is first to come online with the payments server 710 and the payee client is not online with the payments server, the payer client can communicate transaction information from the offline transaction 750 to the payments server 710. The payer client can communicate the transaction information to the payments server 710 to have the offline transaction 750 authenticated so that funds from a suspense account of a payer can be transferred by the bank to a payee account of the payee to complete the payment between the payer and the payee.

FIG. 8 is a schematic diagram showing an example of a payee client 820 that is online with a bank. In FIG. 8, the payee client 820 makes a connection 840 to the payments server 810 to come online with the bank after an offline transaction 850 has been conducted or completed with payer client 830. In other implementations, the payee client 830 comes online with the bank by connecting to another system of the bank such as a payment portal, website, or other online service of the bank. The connection 840 can be made using a suitable communication means such as the internet, internet technologies, or other communication means. In the example, the connection 840 can be used to transmit information to redeem the value of the offline transaction 850 such as transaction information. The connection 840 can also be used to conduct other communications between the payee client and the payments server while the payee client is online with the payments server. In FIG. 8, the payer client 830 is not online with the payments server 810 after the offline transaction 850 has been conducted between the payer client 830, and payee client 820. As the payee client 830 is first to come online with the payments server 810 and the payer client 830 is not online with the payments server, the payee client can communicate transaction information from the offline transaction 850. The payee client can communicate the transaction information to the payments server 810 to have the offline transaction 850 authenticated so that funds from a suspense account of a payer can be transferred by the bank to a payee account of the payee to complete the payment between the payer and the payee.

FIG. 9 is a schematic diagram that shows an example of a payee client 920 and a payer client 930 that are online with a payments server 910. In FIG. 9, the payee client 920 is online with the payments server 910 using connection 940 after an offline transaction 960 has been completed. Also, the payer client 930 is online with the payments server 910 using connection 950 after the offline transaction 960 has been completed between the payee client 920 and the payer client 930. As both the payer client 930 and the payee client 940 are online with the payments server 910, after transaction information has been transmitted to the payments server to redeem payment and funds have been transferred to complete payment for the offline transaction 960, if either the payee client or the payer client submits transaction information to redeem payment, the payment redemption request can be determined to be a duplicate and the bank can deny paying the value of the offline transaction 960 a second time.

### Exemplary Computing Environment

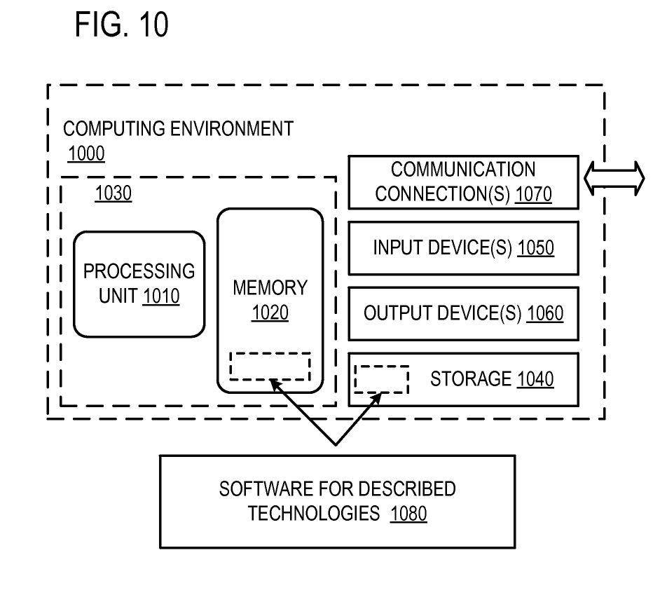

FIG. 10 illustrates a generalized example of a suitable computing environment 1000 in which herein described embodiments, techniques, solutions, and technologies may be implemented. The computing environment 1000 is not intended to suggest any limitation as to scope of use or functionality of the technology, as the technology may be implemented in diverse general-purpose or special-purpose computing environments or systems. For example, the disclosed technology may be implemented using one or more computing devices comprising a processing unit, memory, and storage storing computer-executable instructions implementing the technologies described herein. For example, computing devices include server computers, desktop computers, laptop computers, notebook computers, netbooks, tablet computers, mobile devices, PDA devices and other types of computing devices (e.g., devices such as televisions, media players, or other types of entertainment devices that comprise computing capabilities such as audio/video streaming capabilities and/or network access capabilities). The disclosed technology may also be implemented with other computer system configurations, including hand held devices, multiprocessor systems, consoles, microprocessor-based or programmable consumer electronics, network PCs, minicomputers, mainframe computers, a collection of client/server systems, or the like. The disclosed technology may also be practiced in distributed computing environments where tasks are performed by remote processing devices that are linked through a communications network (e.g., a local network, non-local network, and/or the Internet). In a distributed computing environment, program modules may be located in both local and remote memory storage devices. Additionally, the techniques, technologies, and solutions described herein can be performed in a cloud computing environment (e.g., comprising virtual machines and underlying infrastructure resources).

With reference to FIG. 10, the computing environment 1000 includes at least one central processing unit 1010 and memory 1020. In FIG. 10, this basic configuration 1030 is included within a dashed line. The central processing unit 1010 executes computer-executable instructions. In a multi-processing system, multiple processing units execute computer-executable instructions to increase processing power and as such, multiple processors can be running simultaneously. The memory 1020 may be volatile memory (e.g., registers, cache, RAM), non-volatile memory (e.g., ROM, EEPROM, flash memory, etc.), or some combination of the two. The memory 1020 stores software 1080 that can, for example, implement one or more of the technologies described herein. A computing environment may have additional features. For example, the computing environment 1000 includes storage 1040, one or more input devices 1050, one or more output devices 1060, and one or more communication connections 1070. An interconnection mechanism (not shown) such as a bus, a controller, or a network, interconnects the components of the computing environment 1000. Typically, operating system software (not shown) provides an operating environment for other software executing in the computing environment 1000, and coordinates activities of the components of the computing environment 1000.

The storage 1040 may be removable or non-removable, and includes magnetic disks, magnetic tapes or cassettes, CD-ROMs, CD-RWs, DVDs, or any other tangible storage medium which can be used to store information and which can be accessed within the computing environment 1000. The storage 1040 stores computer-executable instructions for the software 1080, which can implement technologies described herein.

The input device(s) 1050 may be a touch input device, such as a keyboard, keypad, mouse, touch screen, controller, pen, or trackball, a voice input device, a scanning device, or another device, that provides input to the computing environment 1000. For audio, the input device(s) 1050 may be a sound card or similar device that accepts audio input in analog or digital form, or a CD-ROM reader that provides audio samples to the computing environment 1000. The output device(s) 1060 may be a display, printer, speaker, CD-writer, DVD-writer, or another device that provides output from the computing environment 1000.

The communication connection(s) 1070 enable communication over a communication medium (e.g., a connecting network) to another computing entity. The communication medium conveys information such as computer-executable instructions, compressed graphics information, compressed or uncompressed video information, or other data in a modulated data signal.

### Further Considerations

Any of the disclosed methods and/or modules can be implemented using computer-executable instructions stored on one or more computer-readable media (tangible computer-readable storage media, such as one or more optical media discs, volatile memory components (such as DRAM or SRAM), or nonvolatile memory components (such as hard drives)) and executed on a computing device (e.g., any commercially available computer, including smart phones or other mobile devices that include computing hardware). By way of example, computer-readable media include memory 1020 and/or storage 1040. As should be readily understood, the term computer-readable media does not include communication connections (e.g., 1070) such as modulated data signals.

Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to a particular type of hardware. Certain details of suitable computers and hardware are well known and need not be set forth in detail in this disclosure.

Furthermore, any of the software-based embodiments (comprising, for example, computer-executable instructions for causing a computing device to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims and their equivalents. We therefore claim as our invention all that comes within the scope of these claims and their equivalents.

We claim:

1. A method implemented at least in part using a computer, the method comprising:
at a bank, maintaining at least one payee account, at least one payer account, and at least one suspense account;
assigning at least one client identifier to a software client;
generating at least one payment token;
issuing the at least one payment token to the software client;
transferring funds from the at least one payer account to the at least one suspense account;
receiving transaction information for an offline transaction, the transaction information comprising a payment amount, the at least one payment token, and an issuer identifier;
using at least a portion of the transaction information, performing transaction authentication; and
based at least in part on the transaction authentication, transferring funds from the at least one suspense account, or denying a funds transfer.

2. The method of claim 1 wherein the transferring funds from the at least one suspense account comprises an intra-bank funds transfer from the at least one suspense account to the at least one payee account; and
wherein the transferring the funds from the at least one payer account to the at least one suspense account comprises an intra-bank funds transfer between the payer account and the suspense account.

3. The method of claim 1 wherein the performing the transaction authentication comprises:
comparing the received payment token with the at least on payment token issuer identifier and the at least one client identifier; and
comparing the issuer identifier with the at least on client identifier of the software client that was issued the at least one payment token.

4. The method of claim 1 wherein a client transaction account balance is set based on an amount of funds in the at least one suspense account;
wherein an offline transaction limit is set based on the amount of funds in the at least one suspense account;
wherein the offline transaction is conducted using the payment token;
wherein the client transaction account balance is updated based on the payment amount; and
wherein the client transaction account balance is synchronized with the at least one suspense account.

5. The method of claim 4 wherein access to the software client is authenticated at least by decrypting a stored username using a password and matching the stored username to an entered username.

6. The method of claim 1 wherein the at least one payment token is authorized for use within a payment amount range.

7. The method of claim 1 further comprising designating a validity period for the at least one payment token.

8. The method of claim 1 wherein the at least one payment token is a one-time payment token.

9. The method of claim 1 wherein the transaction information is received from at least one of a payee and a payer.

10. The method of claim 1 further comprising issuing a plurality of payment tokens to the software client up to a predetermined amount of payment tokens.

11. The method of claim 1 further comprising changing authorization for a second software client to conduct offline payments.

12. The method of claim 1 wherein the at least one payment token is a first universally unique identifier (UUID), and the at least one client identifier is a different UUID.

13. A computing system comprising a processor and memory, the memory storing computer-executable instructions which when executed cause the computing system to perform a method, the method comprising:
at a payer client provided by a bank, receiving a client identifier from the bank;
receiving at least one payment token from the bank;
setting an offline transaction limit for the payer client;
determining a client transaction account balance based on a balance of a suspense account maintained by the bank;
authenticating access to the payer client;
using the at least one payment token, conducting an offline transaction with a payee client provided by the bank to make a payment for a payment amount;
based on the payment amount, updating the client transaction account balance;
while online with the bank, communicating transaction information to the bank to transfer funds from the suspense account to a payee account maintained by the bank; and
while online with the bank, synchronizing the client transaction account balance with the balance of the suspense account.

14. The computing system of claim 13 further comprising enforcing the offline transaction limit.

15. The computing system of claim 13 wherein the conducting the transaction offline comprises sending transaction information to a payee, the transaction information comprising the payment amount, the payment token, and an issuer identifier.

16. The method of claim 15 wherein the payee is listed as a trusted party in a trusted parties list at the payer client.

17. The method of claim 15 wherein the offline transaction occurs without communication between the payer client and the bank and without communication between the payee client and the bank.

18. The computing system of claim 13 wherein the conducting the transaction offline comprises verifying a personal identification number using the payer client.

19. The method of claim 13 further comprising verifying a personal identification number to add new payees to a trusted parties list.

20. A computing system comprising a processor and memory, the memory storing computer-executable instructions which when executed cause the computing system to perform a method, the method comprising:
at a bank, maintaining a payee account, a payer account, and a suspense account;
assigning a client identifier to a software client;
generating at least one payment token;
issuing the at least one payment token to the software client;
transferring funds from the at least one payer account to the at least one suspense account;
receiving transaction information for an offline transaction, the transaction information comprising a payment amount, received payment token, and an issuer identifier;
using at least a portion of the transaction information, performing transaction authentication; and
based at least in part on the transaction authentication, transferring funds from the at least one suspense account, or denying a funds transfer.

21. A computer-readable storage medium storing computer-executable instructions that when executed cause a computing system to perform a method, the method comprising;
at a bank, maintaining at least one payee account, at least one payer account, and at least one suspense account;
activating a software client from the bank;
associating the software client with the at least one suspense account;
assigning a client identifier to the software client;
generating at least one payment token;
issuing the at least one payment token to the software client;
setting an offline transaction limit;
transferring funds from the at least one payer account to the at least one suspense account based on the offline transaction limit;
enforcing the offline transaction limit;
conducting an offline transaction using the payment token;
receiving transaction information for an offline transaction from the software client when the software client comes online, the transaction information comprising a payment amount, received payment token, and an issuer identifier;
using at least a portion of the transaction information, performing transaction authentication; and
based at least in part on the transaction authentication, transferring funds to the at least one payee account from the at least one suspense account, or denying a funds transfer.
